(19) United States
(12) Patent Application Publication
(10) Pub. No.: US 2026/0229945 A1
(43) Pub. Date: Aug. 6, 2026

(54) MOTOR

(71) Applicant: Panasonic Intellectual Property Management Co., Ltd., Osaka (JP)

(72) Inventors: Atsufumi KIKUCHI, Osaka (JP); Kazuyuki SAKIYAMA, Osaka (JP)

(21) Appl. No.: 19/151,497

(22) PCT Filed: Mar. 15, 2024
(86) PCT No.: PCT/JP2024/010292

§ 371 Date: Jul. 28, 2025

(30) Foreign Application Priority Data
Mar. 23, 2023 (JP) 2023-047327

(51) Int. Cl. H02K 3/28; H02K 1/14; H02K 1/278; H02K 3/18

(52) U.S. Cl. CPC H02K 3/28; H02K 1/146; H02K 1/278; H02K 3/18; H02K 2213/03

(57) ABSTRACT

A motor includes a rotor and a stator. The rotor includes a rotor yoke and a plurality of magnets. The stator includes a stator core including a plurality of teeth and a plurality of winding wires wound around the plurality of teeth, respectively. A wire serving as each of the plurality of winding wires includes a plurality of first narrower width portions and a plurality of second narrower width portions which are alternately arranged in a radial direction. Each of the plurality of first narrower width portions is a portion formed to have a narrowed width by providing a first cutout for a portion, located closer to a corresponding one of teeth, of the wire. Each of the plurality of second narrower width portions is a portion formed to have a narrowed width by providing a second cutout for portion, located more distant from a corresponding one of teeth, of the wire.

### TECHNICAL FIELD

The present disclosure generally relates to a motor, and more particularly relates to a motor including a rotor and a stator with the stator including a plurality of winding wires.

### BACKGROUND ART

Patent Literature 1 discloses a technique for cutting down eddy current loss in a motor including a rotor and a stator with the stator including a plurality of winding wires. According to this technique, each layer of the winding wires has a recess to reduce the loop size of the eddy current.

### CITATION LIST

### Patent Literature

Patent Literature 1: WO 2019/203076 A1

### SUMMARY OF INVENTION

According to the known technique described above, the recesses of the respective layers of each of the winding wires are provided to be aligned in line in a radial direction defined with respect to the stator. This technique requires satisfying conditions such as an operating frequency range to achieve the advantage of reducing the loop size of the eddy current.

An object of the present disclosure is to provide a motor contributing to effectively cut down eddy current loss caused to a winding wire without depending on the conditions such as an operating frequency range.

A motor according to an aspect of the present disclosure includes a rotor and a stator having a radial direction, a circumferential direction, and an axial direction. The rotor includes a rotor yoke and a plurality of magnets arranged on an outer circumferential surface of the rotor yoke. The stator includes: a stator core including a plurality of teeth which are arranged to be spaced apart from each other at intervals in the circumferential direction and protrude inward in the radial direction; and a plurality of winding wires wound around the plurality of teeth, respectively.

Each of the plurality of winding wires is formed by winding a wire having a flat and rectangular shape around a corresponding one of the plurality of teeth. The wire serving as each of the plurality of winding wires includes a plurality of first narrower width portions and a plurality of second narrower width portions. The plurality of first narrower width portions and the plurality of second narrower width portions are alternately arranged in the radial direction.

Each of the plurality of first narrower width portions is a portion formed to have a narrowed width by providing a first cutout for a portion, located closer to the corresponding one of teeth, of the wire. Each of the plurality of second narrower width portions is a portion formed to have a narrowed width by providing a second cutout for portion, located more distant from the corresponding one of teeth, of the wire.

### BRIEF DESCRIPTION OF DRAWINGS

FIG. 1 is a plan view illustrating a motor according to one embodiment;

FIG. 2 is a cross-sectional view thereof taken along the plane A-A shown in FIG. 1;

FIG. 3 is a perspective view illustrating a main part of the motor;

FIG. 4 is a front view illustrating a winding wire included in the motor;

FIG. 5 is a perspective view illustrating the winding wire;

FIG. 6 is a schematic cross-sectional view of a main part illustrating the effect of the motor;

FIG. 7 is a schematic cross-sectional view of a main part showing directions of fluxes caused in FIG. 6;

FIG. 8 is a perspective view illustrating a winding wire according to a first variation; and

FIG. 9 is a perspective view illustrating a winding wire according to a second variation.

### DESCRIPTION OF EMBODIMENTS

### Embodiment

A motor according to the present disclosure will be described with reference to the accompanying drawings. Note that the configuration to be described below is only an exemplary one of various embodiments of the present disclosure and should not be construed as limiting. Rather, the exemplary embodiment may be readily modified in various manners depending on a design choice or any other factor without departing from a true spirit and scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio.

### Overview

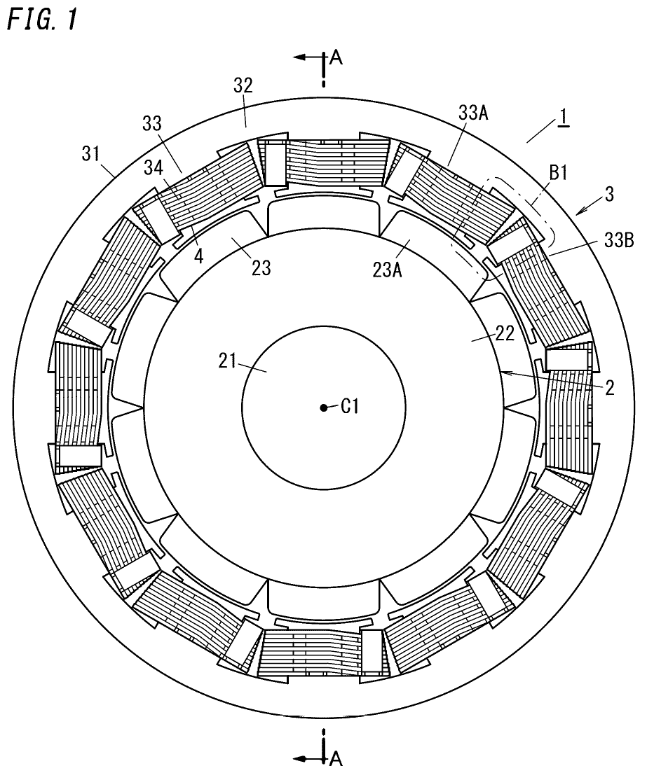

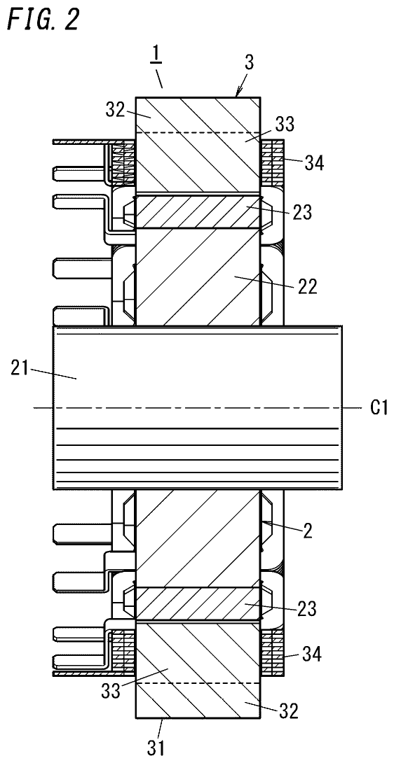

As shown in FIGS. 1 and 2 and other drawings, the motor 1 according to one embodiment includes a rotor 2 and a stator 3.

The rotor 2 includes: a rotary shaft 21 having the shape of a column, of which the rotational axis is defined by a center axis C1; a rotor yoke 22 coupled to the rotary shaft 2; and a plurality of magnets 23. The center axis C1 is a virtual axis. The rotor yoke 22 is a cylindrical member having an outer circumferential surface. The plurality of magnets 23 are mounted on the outer side surface of the rotor yoke 22. The plurality of magnets 23 are arranged along a circumferential direction defined with respect to the rotor yoke 22.

The stator 3 has a stator yoke 32 having the shape of a cylinder, a plurality of teeth 33, and a plurality of winding wires 34.

The stator 3 is arranged to be concentric with the rotor 2. The stator 3 has a radial direction, a circumferential direction, and an axial direction. When the stator 3 is arranged to be concentric with the rotor 2, the radial direction defined with respect to the stator 3 is aligned with the radial direction defined with respect to the rotor 2, the circumferential direction defined with respect to the stator 3 is aligned with the circumferential direction defined with respect to the rotor 2, and the axial direction defined with respect to the stator 3 is aligned with the axial direction defined with respect to the rotor 2.

The plurality of teeth 33 protrude inward in the radial direction (i.e., toward the rotor 2) from a plurality of points on the inner circumferential surface of the stator yoke 32. The plurality of points are set to be spaced apart from each other at intervals in the circumferential direction.

Each of the plurality of winding wires 34 is wound spirally around a corresponding one of the plurality of teeth 33. The plurality of winding wires 34 correspond one to one to the plurality of teeth 33. Each of the plurality of winding wires 34 is formed by winding, in multiple layers, a wire 4 having a flat and rectangular shape around the outer circumferential surface of the corresponding one of the plurality of teeth 33.

The wire 4 having the flat and rectangular shape which serves as each of the plurality of winding wires 34 does not have an equal width along the entire length but has a plurality of first narrower width portions 41 and a plurality of second narrower width portions 42 locally as respective parts thereof. In each of the winding wires 34, the plurality of first narrower width portions 41 and the plurality of second narrower width portions 42 of the wire 4 are alternately arranged in the radial direction defined with respect to the stator 3.

As used herein, the “axial direction” defined with respect to the rotor 2 is aligned with a direction in which the rotary shaft 21 extends. In other words, the “axial direction” is aligned with the direction in which the center axis C1 of the rotary shaft 21 extends. The radial direction defined with respect to the rotor 2 intersects at right angles with the axial direction defined with respect to the rotor 2. The rotor yoke 22 is rotatable in the circumferential direction defined with respect to the rotor 2 on the center axis C1 of the rotary shaft 21. The axial direction defined with respect to the stator 3 is aligned with the direction in which the center axis C1 of the rotary shaft 21 extends. The radial direction defined with respect to the stator 3 intersects at right angles with the axial direction defined with respect to the stator 3. The stator yoke 32 is continuous endlessly in the circumferential direction defined with respect to the stator 3.

As used herein, the phrase “intersecting at right angles” refers to not only a situation where the angle formed between two lines is exactly equal to 90 degrees but also a situation where the two lines intersect with each other at substantially right angles (hereinafter referred to as “two perpendicular lines”), of which the difference from 90 degrees falls within a certain tolerance range. That is to say, the angle formed between two perpendicular lines is different from 90 degrees by not more than the certain tolerance (e.g., a range from 80 degrees to 100 degrees).

### (2) Details

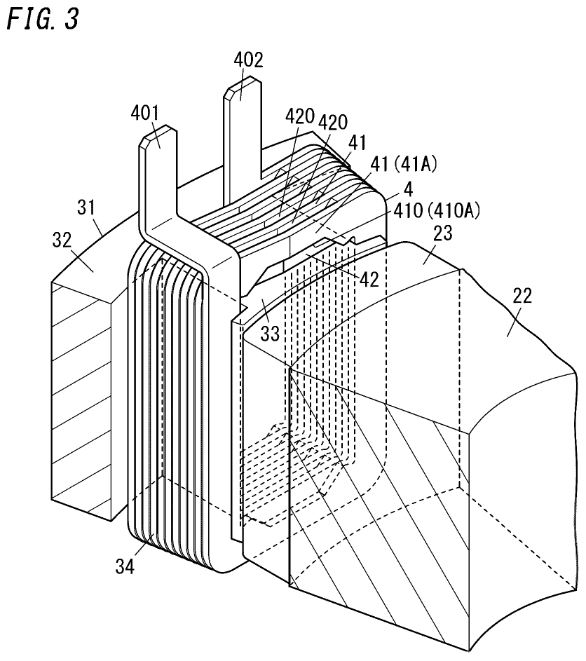

Next, a motor 1 according to one embodiment will be described with reference to FIGS. 1-7.

The motor 1 according to one embodiment is, for example, an inner rotor type brushless motor including the stator 3 in which a rotor 2 is disposed. This motor 1 is, for example, energized and driven by an alternating current with three phases (namely, U-phase, V-phase, and W-phase) which are different from each other by 120 degrees.

The motor 1 includes the rotor 2 and the stator 3. The motor 1 preferably further includes a casing which houses the rotor 2 and stator 3 inside.

### (2.1) Rotor

The rotor 2 includes, as described above, the rotary shaft 21, the rotor yoke 22, and the plurality of magnets 23.

The rotor yoke 22 is formed by, for example, stacking a plurality of non-oriented magnetic steel sheets in the axial direction defined with respect to the rotor 2. Note that the rotor yoke 22 may also be made of iron, silicon steel, permalloy, ferrite, or any other suitable material.

The rotary shaft 21 is inserted into a center hole of the rotor yoke 22. The rotary shaft 21 and the rotor yoke 22 are fixed to each other. The rotor yoke 22 is configured to be rotatable on the center axis C1 along with the rotary shaft 21.

In one embodiment, the rotor 2 is a surface magnet type rotor. The plurality of magnets 23 are mounted on the outer side surface of the rotor yoke 22 to be arranged side by side at regular intervals in the circumferential direction defined with respect to the rotor 2. In one embodiment, ten magnets 23 are mounted at regular intervals on the outer circumferential surface of the rotor yoke 22.

Each of the plurality of magnet 23 is, for example, a permanent magnet having the shape of a rectangular parallelepiped. Each of the plurality of magnets 23 may be a neodymium magnet, for example. The plurality of magnets 23 are mounted on the outer side surface of the rotor yoke 22 so that their N-and S-magnetic poles are alternately arranged in the circumferential direction defined with respect to the rotor 2.

### (2.2) Stator

The stator 3 includes a stator core 31 and the plurality of winding wires 34.

The stator core 31 is configured as a combination of the above-described stator yoke 32 and plurality of teeth 33.

The stator yoke 32 has a cylindrical shape. The stator yoke 32 is formed by, for example, stacking a plurality of non-oriented magnetic steel sheets one on top of another in the axial direction defined with respect to the stator 3. The stator yoke 32 is arranged to be concentric with the rotor 2. In other words, the center axis of the stator yoke 32 having the shape of a cylinder is aligned with the center axis C1 of the rotary shaft 21 of the rotor 2.

The plurality of teeth 33 protrude inward in the radial direction from the inner circumferential surface of the stator yoke 32. The plurality of teeth 33 are arranged to be spaced apart from each other at intervals in the circumferential direction defined with respect to the stator 3. In one embodiment, the plurality of teeth 33 protrude toward the rotor 2 to be arranged side by side at regular intervals in the circumferential direction defined with respect to the stator 3. Each of the plurality of teeth 33 is fixed to the stator yoke 32 by, for example, fitting a part of the tooth 33 into a corresponding one of grooves provided in the stator yoke 32. In this embodiment, the plurality of teeth 33 and the stator yoke 32 are formed separately. However, this should not be construed as limiting. Alternatively, the plurality of teeth 33 and the stator yoke 32 may also be formed integrally.

The plurality of teeth 33 face the rotor yoke 22 in the radial direction defined with respect to the stator 3 with gaps left. Each of the plurality of winding wires 34 is wound spirally around a corresponding one of the plurality of teeth 33 via an insulator having electrical insulating properties.

In one embodiment, twelve teeth 33, for example, are arranged side by side at regular intervals on the inner circumferential surface of the stator yoke 32. A corresponding one of the winding wires 34 is wound around each of the twelve teeth 33. The twelve winding wires 34 are grouped into three groups, each of which corresponds to one of the three phases. Each of the three groups consists of four winding wires 34 that are arranged side by side at regular intervals in the circumferential direction defined with respect to the rotor yoke 22. The winding wire 34 is formed by winding, in multiple layers, the wire 4 having a flat and rectangular shape which is made of, for example, copper or a copper alloy. The winding wire 34 may be an edgewise winding wire, for example. In other words, the wire 4 in the flat and rectangular shape is a flat wire.

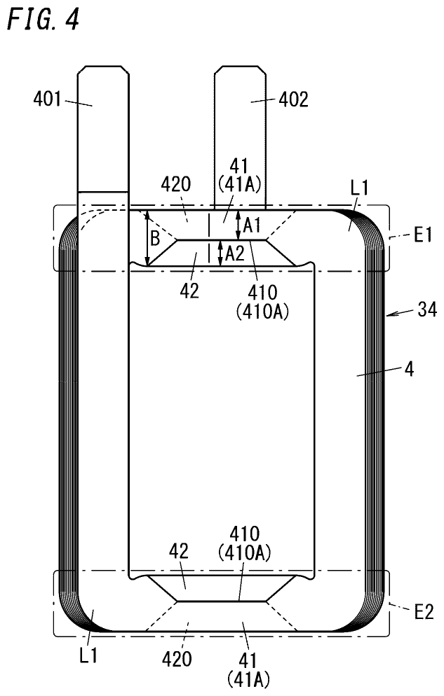

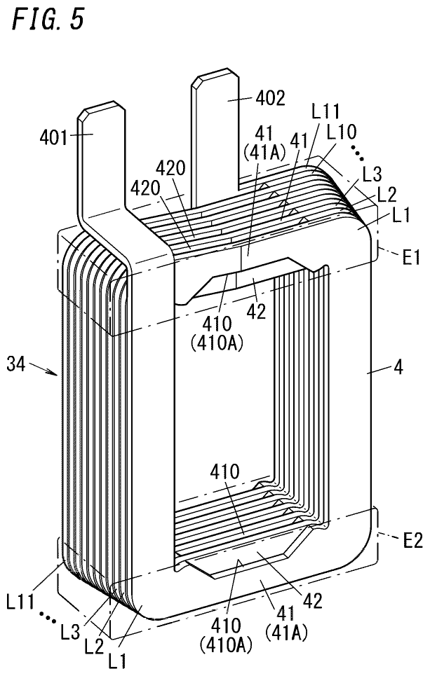

Each of the plurality of winding wires 34 has coil end portions E1, E2 (refer to FIGS. 4 and 5). The coil end portions E1, E2 are the portions, located outside of the stator core 31, of each of the winding wires 34 when the winding wire 34 is viewed in the radial direction defined with respect to the stator 3.

The coil end portions E1, E2 are located opposite from each other in the axial direction defined with respect to the stator 3. The coil end portions E1, E2 consist of a first coil end portion E1 located outside of the stator core 31 on a first side of the axial direction and a second coil end portion E2 located outside of the stator core 31 on a second side of the axial direction. The first and second coil end portions E1, E2 are arranged to be parallel to each other.

The first and second coil end portions E1, E2 are portions not contributing to generating an effective magnetic field that causes the rotor 2 to rotate which form parts of the winding wire 34. As used herein, the phrase “not contributing” refers to not only a situation where something does not contribute to some event in a strict sense of the word but also a situation where the thing may be considered not to contribute to the event substantially.

In one embodiment, the plurality of first narrower width portions 41 and the plurality of second narrower width portions 42 are provided for each of the first and second coil end portions E1, E2. The plurality of first narrower width portions 41 and the plurality of second narrower width portions 42 are arranged alternately one by one in the radial direction defined with respect to the stator 3. In one embodiment, the plurality of first narrower width portions 41 and the plurality of second narrower width portions 42 are provided only for the first and second coil end portions E1, E2.

Each of the plurality of first narrower width portions 41 is a portion formed to have a narrower width than the other surrounding portions thereof by providing a first cutout 410 for the wire 4 having the flat and rectangular shape. The first cutout 410 is provided, with the wire 4 wound around its corresponding tooth 33, at an end edge portion to be located closer to the tooth 33. The first cutout 410 has the shape of being cut out from the end edge portion, located closer to the tooth 33, of the wire 4. The first cutout 410 is opened toward the corresponding tooth 33. The first cutout 410 is a cutout having the shape of a trapezoid which is formed so that its width decreases as the distance from the corresponding tooth 33 increases.

The shape of the first cutout 410 is not limited to this shape but may also be any of a variety of other shapes such as a rectangular shape or a triangular shape. The trapezoidal shape belongs to rectangular shapes. Each of the shapes such as the rectangular shape and the triangle shape does not have to have such a shape that exactly matches the one defined in the field of geometry but may also be a shape which may be regarded as substantially having such a shape. A method for forming the first cutout 410 in the wire 4 may be punching or cutting, and any appropriate method may be adopted.

Each of the plurality of second narrower width portions 42 is a portion formed to have a narrower width than the other surrounding portions by providing a second cutout 420 for the wire 4 having the flat and rectangular shape. The second cutout 420 is provided, with the wire 4 wound around its corresponding tooth 33, at an end edge portion located more distant from the corresponding tooth 33. The second cutout 420 has the shape of being cut out from the end edge portion, located more distant from the corresponding tooth 33, of the wire 4. The second cutout 420 is opened away from the corresponding tooth 33. The first cutout 410 and the second cutout 420 are opened in mutually opposite directions. The second cutout 420 is a cutout having the shape of a trapezoid which is formed so that its width decreases as the distance from the corresponding tooth 33 decreases.

The shape of the second cutout 420 is not limited to this shape but may also be any of a variety of shapes such as a rectangular shape or a triangular shape. The trapezoidal shape belongs to rectangular shapes. Each of the shapes such as the rectangular shape and the triangle shape does not have to have such a shape that exactly matches the one defined in the field of geometry but may also be a shape which may be regarded as substantially having such a shape. A method for forming the second cutout 420 in the wire 4 may be punching or cutting, and any appropriate method may be adopted.

In the first coil end portion E1, the first cutout 410 and the second cutout 420 are formed in an intermediate part of the first coil end portion E1. The first cutout 410 and the second cutout 420 of the first coil end portion E1 are not formed along the entire length of the first coil end portion E1. Likewise, in the second coil end portion E2, the first cutout 410 and the second cutout 420 are formed in an intermediate part of the second coil end portion E2. The first cutout 410 and the second cutout 420 of the second coil end portion E2 are not formed along the entire length of the second coil end portion E2.

Each of the first and second coil end portions E1, E2 has a plurality of layers L1-L11 which are stacked one on top of another in a direction in which a corresponding one of the plurality of teeth 33 protrudes. The plurality of layers L1-L11 form a part of the wire 4 wound, in multiple layers, around its corresponding tooth 33. In the first and second coil end portions E1, E2, both end edges of the plurality of layers L1-L11 which are stacked one on top of another are aligned with each other.

In one embodiment, the plurality of layers L1-L11 are, for example, eleven layers L1-L11. A first end portion 401 and a second end portion 402 serving as both end portions of the wire 4 are extended on the same side of the axial direction defined with respect to the stator 3. That is to say, a direction in which the first end portion 401 of the wire 4 is extended and a direction in which the second end portion 402 of the wire 4 is extended are the same. The first end portion 401 and the second end portion 402 are arranged to be parallel to each other.

Among the plurality of first narrower width portions 41 and the plurality of second narrower width portions 42 provided for each of the first and second coil end portions E1, E2 to be arranged alternately, a first narrower width portion 41A is the innermost one in the radial direction. The first narrower width portion 41A is one first narrower width portion 41 which belongs to the plurality of first narrower width portions 41. The first narrower width portion 41A is located closer to the rotor 2 than any other one of the plurality of first narrower width portions 41 and the plurality of second narrower width portions 42 which are arranged alternately.

In each of the first and second coil end portions E1, E2, the first narrower width portion 41A is provided for the layer L1 that is the innermost layer in the radial direction among the plurality of layers L1-L11. The second narrower width portion 42 is provided for the layer L2 that is the second innermost layer in the radial direction among the plurality of layers L1-L11. The first narrower width portions 41 and the second narrower width portions 42 are provided to be arranged alternately for the third layer L3 through the eleventh layer L11.

In one embodiment, the second end portion 402 is extended from the outermost layer L11 in the radial direction of the first coil end portion E1. In the first coil end portion E1, the plurality of first narrower width portions 41 and the plurality of second narrower width portions 42 are provided alternately for the layers L1-L10, i.e., all of the plurality of layers L1-L11 that are stacked one on top of another but the outermost layer L11. In the second coil end portion E2, the plurality of first narrower width portions 41 and the plurality of second narrower width portions 42 are provided alternately for all of the plurality of layers L1-L11 stacked one on top of another.

The above-described configuration will be described based on the arrangement of the first cutout 410 and the second cutout 420. In this configuration, the plurality of first cutouts 410 and the plurality of second cutouts 420 arranged alternately are provided for each of the first and second coil end portions E1, E2. Among the plurality of first cutouts 410 and the plurality of second cutouts 420 arranged alternately, a first cutout 410A is the innermost one in the radial direction. The first cutout 410A is one first cutout 410 belonging to the plurality of first cutouts 410. The first cutout 410A is located closer to the rotor 2 than any other one of the plurality of first cutouts 410 and the plurality of second cutouts 420 arranged alternately.

The plurality of first cutouts 410 and the plurality of second cutouts 420 arranged alternately are provided for the plurality of layers L1-L11 stacked one on top of another which are included in each of the first and second coil end portions E1, E2. The first cutout 410A is provided for the innermost layer L1 in the radial direction among these plurality of layers L1-L11. The second cutout 420 is provided for the second innermost layer L2 in the radial direction among the plurality of layers L1-L11. The plurality of first cutouts 410 and the plurality of second cutouts 420 are provided to be arranged alternately for the third layer L3 through the eleventh layer L11.

In the first coil end portion E1, the plurality of first cutouts 410 and the plurality of second cutouts 420 are provided alternately for the layers L1-L10, i.e., all of the plurality of layers L1-L11 that are stacked one on top of another but the outermost layer L11. In the second coil end portion E2, the plurality of first cutouts 410 and the plurality of second cutouts 420 are provided alternately for all of the plurality of layers L1-L11 stacked one on top of another.

### (2.3) Effect of Reducing Eddy Current

Next, an eddy current reduction effect to be achieved by providing the plurality of first narrower width portions 41 and the plurality of second narrower width portions 42 for the wire will be described with attention paid to one magnet 23A, (refer to FIG. 1), facing two teeth 33A and 33B that are adjacent to each other along the circumference of the stator 3, among the plurality of magnets 23 mounted on the rotor yoke 22.

If the magnet 23A faces the two adjacent teeth 33A and 33B, a flux B1 emitted from the magnet 23A is swept, for example, by the tooth 33A, and then returns to the magnet 23A from the adjacent tooth 33B via the stator yoke 32. The flow of this flux B1 forms a main flux that causes the rotor 2 to rotate.

On the other hand, the magnet 23A emits not only the main flux but also a leakage flux as well. The leakage flux is a magnetic flux leaking from the stator core 31. Allowing this leakage flux to be interlinked with the winding wire 34, wound around the tooth 33A or 33B, causes an eddy current to be produced in the winding wire 34 and consequently causes eddy current loss due to the production of this eddy current. This eddy current loss brings about generation of heat, thus possibly causing an increase in the temperature of the winding wire 34 and a decrease in the efficiency of the motor 1.

The motor 1 according to one embodiment uses the flat and rectangular wire 4 to form the winding wire 34 to attempt to increase the lamination factor and reduce the DC resistance of the winding wire 34. However, the flat and rectangular wire 4 makes the range, with which the leakage flux is interlinked, larger than in a situation where the wire 4 is a twisted wire or a round wire, thus possibly causing an increase in the eddy current. Therefore, in one embodiment, the plurality of first narrower width portions 41 and the plurality of second narrower width portions 42 arranged alternately are provided for each of the first and second coil end portions E1, E2 of the winding wire 34, as described above. Thus, the mechanism to be described below allows for cutting down the eddy current loss in one embodiment.

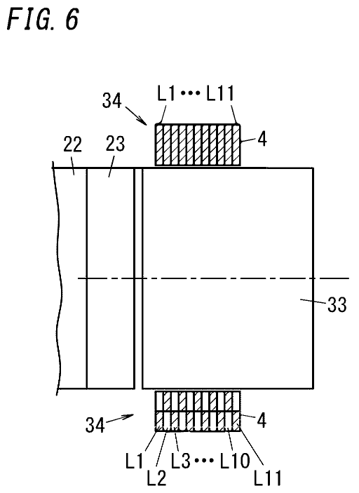

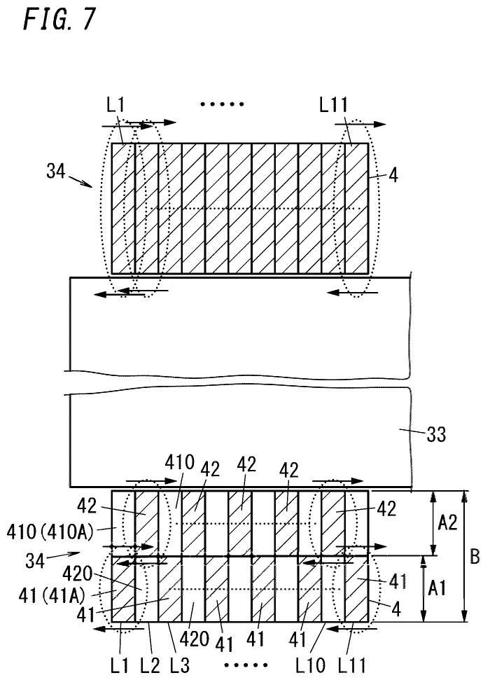

In FIGS. 6 and 7, a winding wire 34 formed out of a wire 4 having a uniform width (i.e., the wire 4 that does not have the plurality of first narrower width portions 41 or the plurality of second narrower width portions 42) is shown, as a cross-sectional view illustrating a comparative example, over a tooth 33 to describe the mechanism of the present disclosure. In FIGS. 6 and 7, the winding wire 34 formed out of the wire 4 according to one embodiment (i.e., the wire 4 in which the plurality of first narrower width portions 41 and the plurality of second narrower width portions 42 are provided) is shown, as a cross-sectional view, under the tooth 33.

In the winding wire 34 according to the comparative example shown over the tooth 33, the directions of fluxes generated by a current that flows in the layers L1-L11 of the winding wire 34 are as indicated by the arrows shown in FIG. 7. This causes the fluxes generated in the respective layers L1-L11 to intensify each other. This increases the current concentration due to the proximity effect, thus causing an increase in effective electrical resistance and eventually an increase in eddy current loss in each of the layers L1-L11.

On the other hand, in the winding wire 34 according to one embodiment shown under the tooth 33, the directions of fluxes generated by a current that flows in the layers L1-L11 of the winding wire 34 are as indicated by the arrows shown in FIG. 7. This causes the fluxes to cancel each other between two adjacent layers. Thus, this allows for reducing the current concentration due to the proximity effect between adjacent layers in the winding wires 34 according to one embodiment. Consequently, the motor 1 according to one embodiment allows for cutting down the eddy current loss in each of the layers L1-L11.

As shown in FIGS. 4 and 7, the width of each of the first narrower width portions 41 of the wire 4 is supposed to be designated by A1 and the width of each of the second narrower width portions 42 of the wire 4 is supposed to be designated by A2. Also, the entire width of the wire 4 without the first narrower width portion 41 or the second narrower width portion 42 (in other words, the width of the wire 4 without the first cutout 410 or the second cutout 420) is supposed to be designated by B. In that case, it is preferable that the A1/B ratio fall within the range from 0.375 to 0.75 and the A2/B ratio fall within the range from 0.375 to 0.75.

According to the result of the simulation carried out by the present inventors, if A1/B=A2/B=1.0 (i.e., if no first cutouts 410 or second cutouts 420 were provided for the wire 4) was met, the eddy current loss was 188.4 mW.

On the other hand, if A1/B=A2/B=0.75 was met, the eddy current loss was 174.2 mW. If A1/B=A2/B=0.625 was met, the eddy current loss was 132.4 mW. If A1/B=A2/B=0.5 was met, the eddy current loss was 119.9 mW. If A1/B=A2/B=0.375 was met, the eddy current loss was 172.2 mW. If A1/B=A2/B=0.25 was met, the eddy current loss was 180.5 mW.

As can be seen from the above-described results of simulations, if the A1/B ratio and the A2/B ratio fall within the range from 0.375 to 0.75, the effect of cutting down the eddy current loss is significant. Therefore, it is preferable to satisfy A1/B=A2/B=0.5 as in one embodiment, in order to maximize the effect of cutting down the eddy current loss.

### (3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure.

Next, variations of the exemplary embodiment will be enumerated one after another. In the following description of variations, any constituent element, having the same function as a counterpart of the embodiment described above, will be designated by the same reference numeral as that counterpart's, and a detailed description thereof will be omitted herein. Note that the variations to be described below may be adopted in combination as appropriate.

### (3.1) First Variation

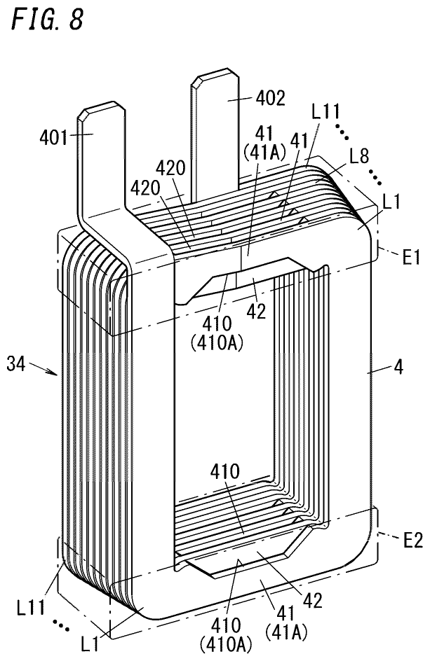

FIG. 8 illustrates a winding wire 34 according to a first variation. In a first coil end portion E1 of the winding wire 34, a plurality of first narrower width portions 41 and a plurality of second narrower width portions 42 are provided to be arranged alternately one by one for layers L1-L8 including the innermost layer L1 out of a plurality of layers L1 to L11 that are stacked one on top of another. No first narrower width portions 41 or second narrower width portions 42 are provided for the other layers. A second coil end portion E2 has the same structure as the first coil end portion E1. The number of layers for which the plurality of first narrower width portions 41 and the plurality of second narrower width portions 42 are provided only needs to be four or more and is not limited to any particular number.

The first variation also achieves, as significantly as in the embodiment described above, the effect of cutting down the eddy current loss.

### (3.2) Second Variation

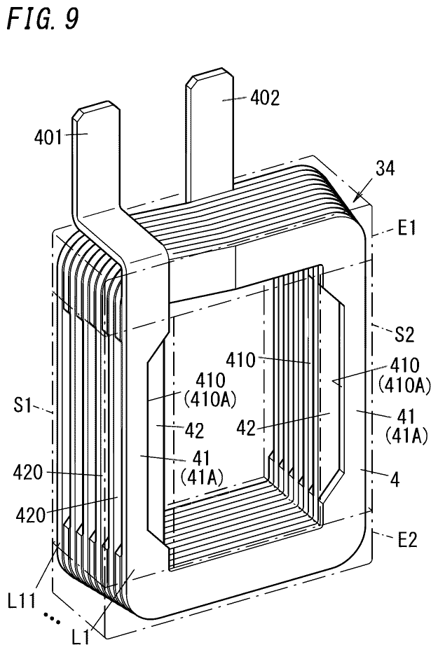

FIG. 9 illustrates a winding wire 34 according to a second variation. In this winding wire 34, a plurality of first narrower width portions 41 and a plurality of second narrower width portions 42 are provided for each of two portions S1, S2 of the winding wire 34 except for the first and second coil end portions E1, E2 so as to be arranged alternately in a radial direction defined with respect to a stator 3. The portions S1, S2 are portions arranged to overlap with a stator core 31 when viewed in radial the direction defined with respect to the stator 3.

Each of the portions S1, S2 has a plurality of layers L1 to L11 that are stacked one on top of another in a direction in which a corresponding one of tooth 33 protrudes. These layers L1-L11 are formed by a part of the wire 4 wound in multiple layers. In the portions S1, S2, both end edges of the plurality of layers L1-L11 which are stacked one on top of another are aligned with each other.

The portions S1, S2 are portions that connect the first and second coil end portions E1, E2. The portions S1, S2 are arranged to be parallel to each other. The winding wire 34 including the first and second coil end portions E1, E2 and the portions S1, S2 has a rectangular shape as viewed in the radial direction defined with respect to the stator 3.

In this second variation, one first narrower width portion 41A belonging to the plurality of first narrower width portions 41 is the innermost one in the radial direction defined with respect to the stator 3 (i.e., located closest to the rotor 2) among the plurality of first narrower width portions 41 and the plurality of second narrower width portions 42 provided to be arranged alternately.

The above-described configuration will be described based on the arrangement of the first cutout 410 and the second cutout 420. In this configuration, the plurality of first cutouts 410 and the plurality of second cutouts 420 arranged alternately in the radial direction defined with respect to the stator 3 are provided for each of the portions S1, S2 of the winding wire 34. Among the plurality of first cutouts 410 and the plurality of second cutouts 420 arranged alternately, one first cutout 410A belonging to the plurality of first cutouts 410 is the innermost one in the radial direction defined with respect to the stator 3 (i.e., located closest to the rotor 2).

The second variation also achieves, as well as the embodiment and first variation described above, the effect of cutting down the eddy current loss. Note that in this second variation, the plurality of first narrower width portions 41 and the plurality of second narrower width portions 42 arranged alternately are provided for both of the portions S1, S2. However, this should not be construed as limiting. Alternatively, the plurality of first narrower width portions 41 and the plurality of second narrower width portions 42 arranged alternately may be provided for only one of the portions S1, S2.

Also, the configuration in which the plurality of first narrower width portions 41 and the plurality of second narrower width portions 42 arranged alternately are provided, as in the one embodiment, for each of the first and second coil end portions E1, E2 of the winding wire 34 may also be adopted along with such a configuration in which the plurality of first narrower width portions 41 and the plurality of second narrower width portions 42 arranged alternately are provided, as in this second variation, for both or one of the portions S1, S2 of the winding wire 34.

(3.2) Other variations

In the above-described embodiment and first and second variations, the plurality of first narrower width portions 41 and the plurality of second narrower width portions 42 are arranged alternately one by one. However, this should not be construed as limiting. Alternatively, the plurality of first narrower width portions 41 and the plurality of second narrower width portions 42 may be arranged, for example, so that a number of (i.e., two or more) first narrower width portions 41 alternate with the same number of second narrower width portions 42. Still alternatively, a single first narrower width portion 41 and a plurality of second narrower width portions 42 may also be arranged alternately. Yet alternatively, a plurality of first narrower width portions 41 and a single second narrower width portion 42 may also be arranged alternately. These arrangements may be modified as needed. Any of these alternative arrangement patterns is included in various arrangement patterns of the plurality of first narrower width portions 41 and the plurality of second narrower width portions 42 arranged alternately.

In the above-described embodiment and first and second variations, the plurality of first narrower width portions 41 have a uniform width Al and the plurality of second narrower width portions 42 also have a uniform width A2. However, these widths do not have to be uniform. For example, the widths A1 of the first narrower width portions 41 may be set so that their widths decrease outward in the radial direction as the distance from the rotor increases (i.e., so that a first narrower width portion 41 provided as the outermost one in the radial direction has the narrowest width A1). In the same way, the widths A2 of the second narrower width portions 42 may also be set so that their widths decrease outward in the radial direction as the distance from the rotor increases (i.e., so that a second narrower width portion 42 provided as the outermost one in the radial direction has the narrowest width A2). The width A1 of each of the first narrower width portions 41 and the width A2 of each of the second narrower width portions 42 may be modified as needed.

Although the present disclosure has been described above with respect to the exemplary embodiment and its variations illustrated on the accompanying drawings, the embodiment and its variations described above are only an exemplary one of various embodiments of the present disclosure and its variations and should not be construed as limiting. Rather, the variations may also be readily modified in various manners depending on a design choice or any other factor without departing from the scope of the present disclosure. Optionally, the configurations described above for those variations may also be adopted in combination as appropriate.

### (4) Recapitulation

A motor (1) according to a first aspect includes a rotor (2) and a stator (3) having a radial direction, a circumferential direction, and an axial direction. The rotor (2) includes a rotor yoke (22) and a plurality of magnets (23) arranged on an outer circumferential surface of the rotor yoke (22). The stator (3) includes: a stator core (31) including a plurality of teeth (33) which are arranged to be spaced apart from each other at intervals in the circumferential direction and protrude inward in the radial direction; and a plurality of winding wires (34) wound around the plurality of teeth (33), respectively. Each of the plurality of winding wires (34) is formed by winding a wire (4) having a flat and rectangular shape around a corresponding one of the plurality of teeth (33). The wire (4) serving as each of the plurality of winding wires (34) includes a plurality of first narrower width portions (41) and a plurality of second narrower width portions (42). The plurality of first narrower width portions (41) and the plurality of second narrower width portions (42) are alternately arranged in the radial direction. Each of the plurality of first narrower width portions (41) is a portion formed to have a narrowed width by providing a first cutout (410) for a portion, located closer to the corresponding one of teeth (33), of the wire (4). Each of the plurality of second narrower width portions (42) is a portion formed to have a narrowed width by providing a second cutout (420) for portion, located more distant from the corresponding one of teeth (33), of the wire (4).

According to this aspect, providing the plurality of first narrower width portions (41) and the plurality of second narrower width portions (42) arranged alternately for each of the winding wires (34) causes the fluxes to cancel each other in the winding wire (34). This allows for reducing the current concentration due to the proximity effect and thus cutting down the eddy current loss consequently. That is to say, this aspect allows for effectively cutting down the eddy current loss caused to the winding wire (34) without having to satisfy, as in the known technique, various conditions such as the one concerning an operating frequency range.

In a motor (1) according to a second aspect, which may be implemented in conjunction with the first aspect, when a width of each of the plurality of first narrower width portions (41) is designated by A1, a width of each of the plurality of second narrower width portions (42) is designated by A2, and a width of the wire (4) without the first narrower width portion (41) or the second narrower width portion (42) is designated by B, an A1/B ratio falls within a range from 0.375 to 0.75 and an A2/B ratio falls within a range from 0.375 to 0.75.

This aspect allows for effectively cutting down the eddy current loss caused to the winding wire (34).

In a motor (1) according to a third aspect, which may be implemented in conjunction with the first or second aspect, one first narrower width portion (41) belonging to the plurality of first narrower width portions (41) is an innermost one in the radial direction among the plurality of first narrower width portions (41) and the plurality of second narrower width portions (42) that are arranged alternately.

This aspect allows for providing the first cutout (410) for a part on which a leakage flux has significant impact, thus contributing to effectively cutting down the eddy current loss caused to the winding wire (34).

In a motor (1) according to a fourth aspect, which may be implemented in conjunction with any one of the first to third aspects, each of the plurality of winding wires (34) has a coil end portion (E1, E2) located outside of the stator core (31) when viewed in the radial direction. The plurality of first narrower width portions (41) and the plurality of second narrower width portions (42) arranged alternately are provided for the coil end portion (E1, E2).

According to this aspect, providing the plurality of first narrower width portions (41) and the plurality of second narrower width portions (42) arranged alternately for the coil end portion (E1, E2) on which a leakage flux has significant impact allows for effectively cutting down the eddy current loss caused to the winding wire (34).

In a motor (1) according to a fifth aspect, which may be implemented in conjunction with the fourth aspect, the coil end portion (E1, E2) has a plurality of layers (L1-L11) which are stacked one on top of another in the radial direction. An innermost layer (L1) provided in the radial direction which belongs to the plurality of layers (L1-L11) has one first narrower width portion (41) belonging to the plurality of first narrower width portions (41).

This aspect allows for providing the first cutout (410) for a part on which a leakage flux has significant impact, thus contributing to effectively cutting down the eddy current loss caused to the winding wire (34).

In a motor (1) according to a sixth aspect, which may be implemented in conjunction with any one of the first to third aspects, each of the plurality of winding wires (34) has a first coil end portion (E1) and a second coil end portion (E2) which are provided outside of the stator core (31) when viewed in the radial direction. The plurality of first narrower width portions (41) and the plurality of second narrower width portions (42) arranged alternately are provided for each of the first coil end portion (E1) and the second coil end portion (E2).

According to this aspect, providing the plurality of first narrower width portions (41) and the plurality of second narrower width portions (42) arranged alternately for both the first coil end portion (E1) and the second coil end portion (E2) on each of which a leakage flux has significant impact allows for effectively cutting down the eddy current loss caused to the winding wire (34).

In a motor (1) according to a seventh aspect, which may be implemented in conjunction with the sixth aspect, each of the first coil end portion (E1) and the second coil end portion (E2) has a plurality of layers (L1-L11) which are stacked one on top of another in the radial direction. An innermost layer (L1) provided in the radial direction which belongs to the plurality of layers (L1-L11) has one first narrower width portion (41) belonging to the plurality of first narrower width portions (41).

This aspect allows for providing the first cutout (410) for a part on which a leakage flux has significant impact, thus contributing to effectively cutting down the eddy current loss caused to the winding wire (34).

In a motor (1) according to an eighth aspect, which may be implemented in conjunction with any one of the first to seventh aspects, each of the plurality of winding wires (34) includes a portion (S1, S2) which is arranged to overlap with the stator core (31) when viewed in the radial direction. The plurality of first narrower width portions (41) and the plurality of second narrower width portions (42) arranged alternately are provided for the portion (S1, S2).

This aspect also allows for effectively cutting down the eddy current loss caused to the winding wire (34).

### REFERENCE SIGNS LIST

1 Motor
2 Rotor
22 Rotor Yoke
23 Magnet
3 Stator
31 Stator Core
33 Tooth
34 Winding Wire
4 Wire
41 First Narrower Width Portion
410 First Cutout
42 Second Narrower Width Portion
420 Second Cutout
E1 First Coil End Portion
E2 Second Coil End Portion
S1 Portion
S2 Portion
L1-L11 Layer

1. A motor comprising:
a rotor; and
a stator having a radial direction, a circumferential direction, and an axial direction, the rotor including:
a rotor yoke; and
a plurality of magnets arranged on an outer circumferential surface of the rotor yoke, the stator including:
a stator core including a plurality of teeth, the plurality of teeth being arranged to be spaced apart from each other at intervals in the circumferential direction and protruding inward in the radial direction; and
a plurality of winding wires wound around the plurality of teeth, respectively,
each of the plurality of winding wires being formed by winding a wire having a flat and rectangular shape around a corresponding one of the plurality of teeth,
the wire serving as each of the plurality of winding wires including a plurality of first narrower width portions and a plurality of second narrower width portions, the plurality of first narrower width portions and the plurality of second narrower width portions being alternately arranged in the radial direction,
each of the plurality of first narrower width portions being a portion formed to have a narrowed width by providing a first cutout for a portion, located closer to the corresponding one of teeth, of the wire, and
each of the plurality of second narrower width portions being a portion formed to have a narrowed width by providing a second cutout for portion, located more distant from the corresponding one of teeth, of the wire.

2. The motor of claim 1, wherein
when a width of each of the plurality of first narrower width portions is designated by A1, a width of each of the plurality of second narrower width portions is designated by A2, and a width of the wire without the first narrower width portion or the second narrower width portion is designated by B:
an A1/B ratio falls within a range from 0.375 to 0.75; and
an A2/B ratio falls within a range from 0.375 to 0.75.

3. The motor of claim 1, wherein
one first narrower width portion belonging to the plurality of first narrower width portions is an innermost one in the radial direction among the plurality of first narrower width portions and the plurality of second narrower width portions that are arranged alternately.

4. The motor of claim 1, wherein
each of the plurality of winding wires has a coil end portion located outside of the stator core when viewed in the radial direction, and
the plurality of first narrower width portions and the plurality of second narrower width portions arranged alternately are provided for the coil end portion.

5. The motor of claim 4, wherein
the coil end portion has a plurality of layers which are stacked one on top of another in the radial direction, and
an innermost layer provided in the radial direction which belongs to the plurality of layers has one first narrower width portion belonging to the plurality of first narrower width portions.

6. The motor of claim 1, wherein
each of the plurality of winding wires has a first coil end portion and a second coil end portion which are provided outside of the stator core when viewed in the radial direction, and
the plurality of first narrower width portions and the plurality of second narrower width portions arranged alternately are provided for each of the first coil end portion and the second coil end portion.

7. The motor of claim 6, wherein
each of the first coil end portion and the second coil end portion has a plurality of layers which are stacked one on top of another in the radial direction, and
an innermost layer provided in the radial direction which belongs to the plurality of layers has one first narrower width portion belonging to the plurality of first narrower width portions.

8. The motor of claim 1, wherein
each of the plurality of winding wires includes a portion which is arranged to overlap with the stator core when viewed in the radial direction, and
the plurality of first narrower width portions and the plurality of second narrower width portions arranged alternately are provided for the portion.
